(19) United States
(12) Patent Application Publication
(10) Pub. No.: US 2019/0180385 A1
(43) Pub. Date: Jun. 13, 2019

(54) ANALYTICAL TOOL FOR IDENTIFYING TRAINING DOCUMENTS

(71) Applicant: Wells Fargo Bank, N.A., San Francisco, CA (US)

(72) Inventors: Rebecca Stoddard, Atlanta, GA (US); Rishabh Mallick, Denver, CO (US); Philip Perry, Golden, CO (US); Kathryn Seabaugh, Denver, CO (US); Justin Sogge, Parker, CO (US); Mandy Valdes, Englewood, CO (US)

(21) Appl. No.: 15/861,336

(22) Filed: Jan. 3, 2018

Related U.S. Application Data
(60) Provisional application No. 62/597,196, filed on Dec. 11, 2017.

(51) Int. Cl. G06Q 40/00; G06Q 40/02; G06K 9/00; G06F 17/30

(52) U.S. Cl. CPC G06Q 40/125; G06F 17/30011; G06K 9/00442; G06Q 40/02

(57) ABSTRACT

Techniques are described for automatically identifying training documents that are relevant to potential financial errors or issues in electronic financial reports submitted by a customer of a financial entity. A computing device performs efficient identification of potential inconsistencies by receiving customer information for the customer. The computer device determines an expected range for an entry included in a user interface based on the customer information. The entry is configured to collect financial data from the customer for the financial entity. The computing device receives, at the entry included in the user interface, an indication of a financial value that is input by a customer representative. The computing device outputs, to the customer representative via the user interface, based on the financial value being outside of the expected range for the entry, a notification indicating one or more training documents within a searchable library that corresponds to the entry.

This application claims the benefit of U.S. Provisional Application Ser. No. 62/597,196, filed on Dec. 11, 2017, the entire content of which is incorporated herein by reference.

### TECHNICAL FIELD

The disclosure relates to identifying training documents, such as, training documents included in a web-based searchable library.

### BACKGROUND

Financial relationships between a financial institution, such as a bank, credit union, or other lending institution, and a business customer may require periodic financial reports from the business customer. For example, in the case of a supply chain finance relationship, the business customer may purchase goods or services from a vendor, and the financial institution may immediately pay the vendor's invoice for the goods or services based on the business customer's line of credit. As part of the supply chain finance relationship, a customer representative of the business customer may submit the periodic financial reports to the financial institution. In some examples, the customer representative may submit the periodic financial reports directly into an accounting system of the financial institution via one or more networks with little to no interaction with a representative at the financial institution.

The representative at financial institution that is responsible for the supply chain finance relationship with the business customer may assume that the financial reports received from the business customers are accurate. The representative may rely on the information included in the financial reports to approve purchases on the business customer's line of credit or make adjustments to the line of credit. However, some businesses, particularly small businesses, may have owners with little to no formal business training and may not have the resources to hire a chief financial officer (CFO). This may result in frequent errors in the business customer's financial reports to the financial institution and/or financial instability for the business customers as a consequence of poor business decisions.

### SUMMARY

In general, this disclosure describes techniques for automatically identifying training documents that are relevant to potential financial errors or issues in electronic financial reports submitted by a business customer of a financial institution. In response to identifying the potential financial errors or issues, the techniques include identifying the relevant training documents from a searchable library and providing the relevant training documents to the business customer. In this way, the techniques may reduce the occurrence of the identified financial error or issue in the current and subsequent financial reports submitted by the business customer. In addition, the techniques may reduce banking errors due to erroneous financial reporting by customer representatives that are unfamiliar with financial reports and/or lacking financial knowledge. Such banking errors may result in reductions to or even loss of the business customer's credit line.

As one example, a customer representative may electronically submit a monthly financial report that contains a short-term accounts receivables value that is calculated by the customer to include both short-term and long-term accounts receivables values. In this example, in response to identifying that the short-term accounts receivables value input by the customer representative includes both short-term and long-term accounts receivables values, the disclosed techniques may identify training documents relevant to how to calculate a short-term accounts receivables value for a monthly financial report and permit the customer representative to resubmit the financial report with a modified short-term accounts receivables value. In this way, the techniques may train the customer representative regarding one or more most likely financial errors or issues that are arising out of the customer representative's electronic reports without overwhelming the customer representative with an amalgamation of useful and useless training documents, which might be found through an Internet search.

The disclosed techniques enable efficient identification of potential inconsistencies in financial values provided by a customer representative in order to identify relevant training material within a searchable library. In accordance with the disclosed techniques, a computing device performs the identification of potential inconsistencies by determining whether a financial value input by a customer representative at an entry of a user interface is outside of an expected range for the entry. The determination of whether the financial value input by the customer representative is outside of the expected range allows the computing device to efficiently identify one or more training materials that correspond to the entry that are most likely to be relevant to the customer representative. The computing device may identify only training materials that correspond to entries that received financial values input by the customer representative that are outside of their respective expected range, which may greatly reduce a large number (e.g., hundreds, thousands, tens of thousands, etc.) of training documents in a searchable library to a useful number (e.g., 1, 10, etc.) of training documents.

In one example, this disclosure is directed to a computer-based method comprising receiving, by a computing device, customer information for a customer of a financial entity. The method further comprises determining, by the computing device, an expected range for an entry included in a user interface based on the customer information, the entry being configured to collect financial data from the customer for the financial entity. The method further comprises receiving, by the computing device and at the entry included in the user interface, an indication of a financial value that is input by a customer representative associated with the customer of the financial entity. The method further comprises outputting, by the computing device and to the customer representative via the user interface, based on the financial value being outside of the expected range for the entry, a notification indicating one or more training documents within a searchable library that corresponds to the entry.

In another example, this disclosure is directed to a computing device comprising a memory and at least one processor in communication with the memory. The memory is configured to store customer information for a customer of a financial entity. The at least one processor is configured to receive customer information for a customer of a financial entity. The at least one processor is further configured to determine an expected range for an entry included in a user interface based on the customer information, the entry being configured to collect financial data from the customer for the financial entity. The at least one processor is further configured to receive, at the entry included in the user interface, an indication of a financial value that is input by a customer representative associated with the customer of the financial entity. The at least one processor is further configured to output, to the customer representative via the user interface, based on the financial value being outside of the expected range for the entry, a notification indicating one or more training documents within a searchable library that corresponds to the entry.

A non-transitory computer-readable medium comprising instructions that when executed cause one or more processors to receive customer information for a customer of a financial entity. The instructions further cause the one or more processors to determine an expected range for an entry included in a user interface based on the customer information, the entry being configured to collect financial data from the customer for the financial entity. The instructions further cause the one or more processors to receive, at the entry included in the user interface, an indication of a financial value that is input by a customer representative associated with the customer of the financial entity. The instructions further cause the one or more processors to output, to the customer representative via the user interface, based on the financial value being outside of the expected range for the entry, a notification indicating one or more training documents within a searchable library that corresponds to the entry.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example customer service system that includes a computing device configured to identify relevant training material within a searchable library, in accordance with the techniques of this disclosure.

FIG. 2 is a block diagram illustrating an example computing device configured to identify relevant training material within a searchable library, in accordance with the techniques of this disclosure.

FIGS. 3A and 3B are conceptual diagrams illustrating one example user interface at a web browser of a computing device of FIG. 1.

FIGS. 4A and 4B are conceptual diagrams illustrating one example user interface at a software application of a computing device of FIG. 1.

FIG. 5 is a flowchart illustrating an example operation of a computing device configured to identify relevant training material within a searchable library, in accordance with the techniques of this disclosure.

### DETAILED DESCRIPTION

The techniques of this disclosure are directed to a computer-based system including a computing device configured to operate as a “smart bot” to provide financial guidance as a virtual chief financial officer (CFO) to business customers of a bank. In some examples, the techniques may be implemented in the scenario of a supply chain finance relationship in which the business customer is either a supplier of good/services or a buyer of the goods/services. In this scenario, the bank may pay invoices to the vendor/supplier on behalf of the buyer on short payment terms to free up cash flow for the supplier, and the buyer may, in turn, pay the bank on longer payment terms to optimize working capital for the buyer. Regardless of whether the customer is the supplier or the buyer, the bank is taking on the risk that the orders will be fulfilled by the supplier and that the buyer will pay the invoices. As part of the supply chain finance relationship, the bank may require periodic financial reports from the customers. The bank needs these reports to be accurate in order to ensure that their customers are in good financial standing and fulfilling their supply chain contracts. In addition, since the bank has a vested interest in its customers' success, the bank representatives working with the business customers may attempt to provide the customers with financial guidance.

The smart bot described in this disclosure may be executed on a computing device owned by the bank that has access to a public network, such as the Internet, and one or more private networks owned by the bank and at least one customer. For example, for a given customer, the smart bot may have access to bank financial data for the customer from the bank network, customer financial data directly from the customer network, and external market data via the Internet. In addition, the smart bot is configured to analyze and present financial guidance to computing devices of the customer's representatives via the Internet. In some examples, the smart bot may provide a customer web-based portal through which the customer's representative can view the analysis and financial guidance, and a companion mobile device application through which the customer's representatives can receive alerts as push notifications, for example.

In some scenarios, e.g., in the case of a small business where the owner's actions reflect on the business customer as well, the smart bot may track the purchases, behaviors, and locations of the business customer's owner via the owner's mobile device. Such tracking could be used to validate business prospects and meetings that were reported to the bank by the customer, or for the bank to market financial products to the business customer. In addition, such tracking could be used to remind the business customer's owner to not make large purchases based the customer's current financial status.

The smart bot may be configured to analyze the data it receives from the bank network, the customer network, the customer's owner/representatives, and/or external sources, and provide financial guidance to the customer where appropriate. In some examples, the smart bot may provide targeted financial guidance to a business customer based on identified financial weaknesses or financial report issues/discrepancies of the customer. For example, the smart bot may send notifications to the customer including suggested solutions or links to targeted financial tutorials depending on the identified situation. In some cases, the analysis may be fully-automated such that the smart bot identifies financial issues or errors based on the received data and identifies pre-existing articles or training materials to send to the customer's representatives in the form of email attachments or links. In other cases, the analysis may be semi-automated such that the smart bot identifies financial issues or errors based on the received data, and a bank representative provides personalized advice to the customer's representatives via email, text, or telephone conversations. In other examples, the smart bot may provide passive financial guidance to bank customers in the form of a customer portal to a web-based searchable library of financial information and training materials. In still other examples the smart bot may auto-generate financial reports for the bank on behalf of the customer.

As one example, the smart bot may identify when a customer is attempting to export a balance sheet to the bank that does not balance. In response to identifying this error, the smart bot may send a notification of the error to the customer's representative and provide links to tutorials on how to fill out and maintain a balance sheet. In some examples, the smart bot may be configured with a “walk through” feature that provides step-by-step guidance for completing a given report with the customer's representative. The smart bot may also provide a percentile ranking of the customer's financial knowledge and report proficiency compared to the bank's other customers of similar size.

As another example, the smart bot may analyze the customer financial data associated with a certain deal or contract and provide the customer with a percentage probability that the bank will fund the deal or whether the bank will increase the customer's credit limit. This determination may be based primarily on the customer's customer relationship management (CRM) data and may help the customer understand how their actions impact their credit line with the bank. In some cases, the smart bot may suggest a credit line increase or other action by the customer based on upcoming payments on which the customer may default based on their financial data. The smart bot may also correlate the customer's current financial standing with historical financial trend data for other companies, e.g., from the bank or from external market data, and notify the customer's representative that the customer may be headed toward insolvency unless the customer follows the provided financial guidance.

As a further example, the smart bot may automatically generate reports for the bank on behalf of the customer. The smart bot may pull purchase orders identified in the sales pipeline from the customer's CRM data, and generate an accounts receivable report for the bank based on this data. The customer may authorize the smart bot to access certain information and/or generate certain reports on a one-time basis or on a periodic basis, e.g., monthly or quarterly.

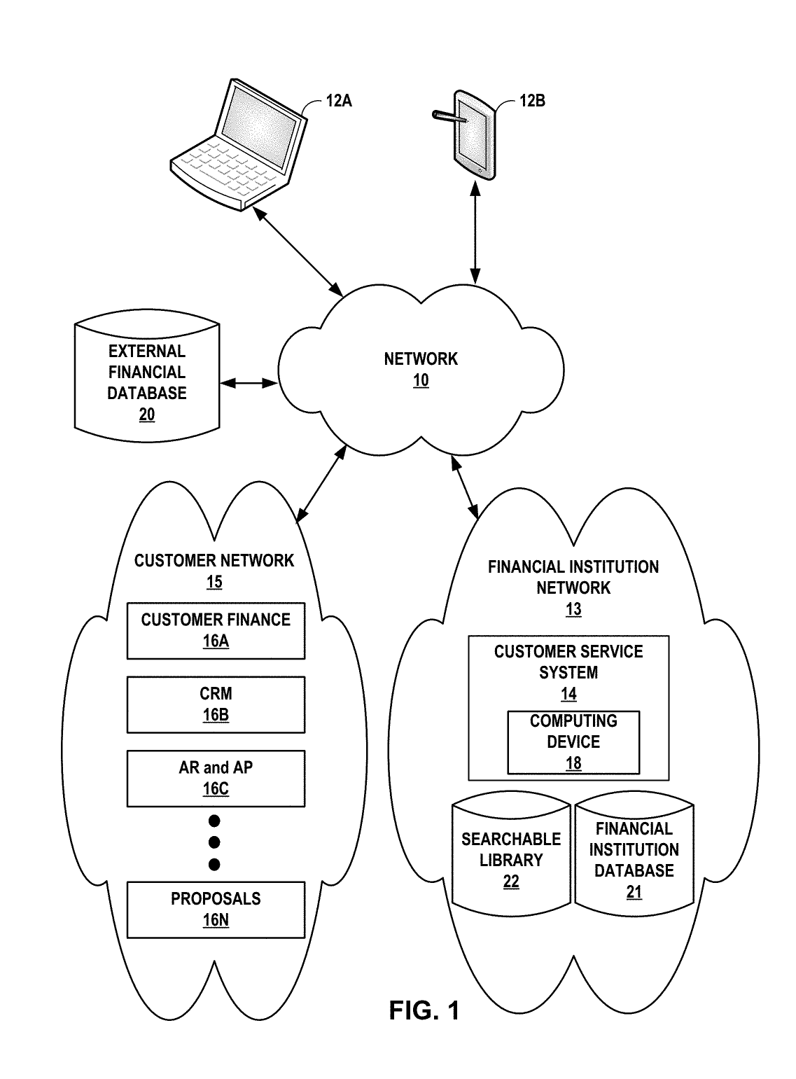

FIG. 1 is a block diagram illustrating an example customer service system 14 that includes a computing device 18 configured to identify relevant training material within searchable library 22, in accordance with the techniques of this disclosure. In some examples, computing device 18 may operate as a smart bot configured to provide financial guidance as a virtual CFO to business customers of a financial institution. As such, computing device 18 may perform any of the functions described above with respect to the smart bot. The features of functions of computing device 18 are described in more detail below.

As discussed in further detail below, a financial entity (e.g., a bank, credit union, etc.) may provide customer service system 14 to permit customer representatives to electronically generate financial reports and submit completed financial reports. Moreover, a financial institution may provide customer service system 14 to permit customer representatives access to training documents for banking transactions.

In a supply chain finance relationship, as discussed above, customer representatives may be required to submit periodic financial reports to the financial institution. The customer representatives may submit the periodic financial reports electronically and directly into an accounting system of the financial institution via one or more networks with little to no interaction with a representative at the financial institution. The electronic financial reporting system may make financial reporting easier for the parties involved, but may also reduce the amount of personal interaction between the customer representatives and the financial institution representatives. In some cases, the electronic financial reporting system may lead to errors by customer representatives with little to no formal business training. Since the financial institution representatives may rely on the information included in the financial reports to approve purchases on or make adjustments to business customers' lines of credit, errors in the financial reports may result in reductions to or even loss of business customers' lines of credit.

Moreover, customer representatives looking to increase or improve their financial knowledge may be overwhelmed with an amount of content available via a search of the Internet or in a searchable library service, such as LexisNexis or Bloomberg. For example, customer representatives may be inundated with an amalgamation of useful and useless training documents when attempting to browse the Internet search results or the searchable library. In another example, customer representatives may not be aware of search terms or search operators used by the searchable library to effectively search for desired training documents. As such, customer representatives may not find conventional searchable libraries helpful and, in some instances, may not utilize training material within conventional searchable libraries.

The disclosed techniques enable computing device 18 within customer service system 14 to perform efficient identification of potential inconsistencies in financial values provided by a customer representative in order to identify relevant training material within searchable library 22. Based on the identified relevant training material, customer service system 14 may output a notification (e.g., a weblink, an in-app message, etc.) indicating the relevant training materials within searchable library 22. In this way, customer service system 14 may identify relevant training material in order to simplify financial transactions and to reduce an occurrence of common financial issues without overwhelming customer representatives with an amalgamation of useful and useless training material.

Customer service system 14 may provide customer service for any business, including, for example, physical and online retail stores, physical and online service providers, hospitals and medical groups, utilities, government bodies, and the like. For purposes of explanation, customer service system 14 is described herein as providing customer service for a financial institution, such as a bank. It should be understood, however, that the financial institution is merely one example, and the application of the disclosed techniques should not be so limited.

In the illustrated example of FIG. 1, customers of a financial institution may access customer service system 14 of the financial institution via customer devices 12A and 12B (collectively “customer devices 12”) and network 10. Customer devices 12 may comprise any of a wide range of user devices used by the customers of the financial institution, including laptop or desktop computers, tablet computers, so-called “smart” phones, “smart” pads, “smart” watches, or other personal digital appliances equipped for wired or wireless communication. Customer devices 12 may each include a display or some other device capable of presenting a user interface provided by customer service system 14. In some examples, the user interface devices of customer devices 12 may be configured to receive tactile, audio, or visual input. In addition to receiving input from users, the user interface devices of customer devices 12 may be configured to output content such as graphical user interfaces (GUIs) for display to the customers, e.g., at display devices associated with customer devices 12.

Customer devices 12 may be configured to receive a user input indicating a financial value for an entry of the user interface of customer service system 14. For example, customer devices 12 may detect an indication of a financial value input by a customer representative and output the financial value to customer service system 14 via network 10. As used herein, a financial value may refer to a monetary, material, or other assessed worth of an asset, liability, good, or service as well as other financial values. For instance, customer device 12A may detect at a keyboard of customer device 12A an indication of a selection of one or more numeric characters representing a financial value (e.g., asset, liability, revenue, etc.) by a customer representative. In some instances, customer device 12B may detect at a soft keyboard displayed on a touch screen of customer device 12B a selection of one or more numeric characters representing a financial value (e.g., asset, liability, etc.) by a customer representative.

Customer devices 12 may include one or more sensors used to verify a customer representative with customer service system 14 of the financial institution. For example, customer device 12B may include a global positioning system (GPS) configured to track a location of customer device 12B. In this example, customer service system 14 may use the tracked location of customer device 12B to verify and/or validate the customer. In some examples, customer service system 14 may use the tracked location of customer device 12B to select marketing material. In some examples, customer service system 14 may use customer device 12B to make a cash advance to the customer against their credit line. For instance, customer service system 14 may use customer device 12B to make a cash advance to the customer against their credit when a tracked location of customer device 12B corresponds to a location for the customer. In some examples, customer device 12B may generate validation information, which may be used by customer service system 14 to verify and/or validate the customer using a multi-factor authentication for money requests.

Customer service system 14 may be part of a centralized or distributed system of one or more computing devices, such as such as desktop computers, laptops, workstations, wireless devices, network-ready appliances, file servers, print servers, or other devices. In some examples, customer service system 14 may be hosted by the financial institution and provide customer service for all or a portion of the financial institution. For example, as shown in FIG. 1, customer service system 14 may be part of a financial institution network 13. In other examples, customer service system 14 may be a third-party customer service provider that provides customer service for multiple different businesses, including the financial institution.

Financial institution network 13 may include financial institution database 21. Financial institution database 21 may include financial data (e.g., bank data) for the financial institution. Examples of information stored in financial institution database 21 may include, but are not limited to, past history with a customer, ancillary group relationships, invoices, triad (e.g., outstanding), borrowing base availability, collateral position, or other information.

As illustrated in FIG. 1, customer devices 12 may communicate with customer service system 14 over a network 10. In some examples, network 10 may comprise a private telecommunications network associated with a business that is hosting customer service system 14, e.g., the financial institution. In other examples, network 10 may comprise a public telecommunications network, such as the Internet. Although illustrated as a single entity, network 10 may comprise any combination of public and/or private telecommunications networks, and any combination of computer or data networks and wired or wireless telephone networks. In some examples, network 10 may comprise one or more of a wide area network (WAN) (e.g., the Internet), a virtual private network (VPN), a local area network (LAN), a wireless local area network (WLAN) (e.g., a Wi-Fi network), a wireless personal area network (WPAN) (e.g., a Bluetooth® network), or the public switched telephone network (PTSN).

Customer service system 14 may communicate with customer network 15 over network 10 to obtain customer information of a customer of financial institution network 13. Customer network 15 may refer to one or more computing devices used by one or more customer representatives associated with a user (e.g., customer) of financial institution network 13. Customer network 15 may be part of a centralized or distributed system of one or more computing devices, such as such as desktop computers, laptops, workstations, wireless devices, network-ready appliances, file servers, print servers, or other devices. In some examples, customer network 15 may be hosted by a customer of the financial institution. In other examples, customer network 15 may be a third-party service provider that provides computing service for multiple different businesses, including the customer of financial institution network 13.

As illustrated in FIG. 1, computing device 18 may receive data from numerous sources. For example, from customer network 15, computing device 18 may receive customer financial information 16A (e.g., customer assets, liabilities, etc.), customer relationship management (CRM) information 16B including customer sales, prospects, pre-sales, sales cycle information, and meeting notes, accounts receivable (AR) and accounts payable (AP) (collectively, “AR and AP 16C”), and a customer proposal information 16N including customer bids and customer wins. From the financial institution network 13, computing device 18 may have access to a financial institution database 21 including financial history and accounts for the customer, credit lines and metrics for the customer, customer invoices, and customer accounts outstanding. In addition, from financial institution network 13, computing device 18 may have access to the customer's borrowing base availability and/or collateral position and the bank's underwriting system. In some examples, from external financial database 20, computing device 18 may have access to external market data, e.g., Moody's® reports.

Financial institution network 13 may include searchable library 22. Searchable library 22 may be any electronic or online catalog or index that contains information that is searchable. For example, documents within searchable library 22 may be categorized such that a customer representative may browse documents associated with one or more selected categories. In some examples, documents within searchable library 22 may be associated with key words such that a customer representative may search for documents associated with one or more key words. In some examples, documents included in searchable library 22 may be financial documents. Examples of financial documents may include, but are not limited to, documents providing definitions of financial terms, documents providing guidance of filing financial forms, documents directed to correcting common financial issues, or other financial documents.

Training materials provided by a financial institution, such as a bank, may generally improve customer service experiences by effectively guiding a customer representative of a customer of the financial institution network 13 to complete financial tasks. Moreover, training materials provided by a financial institution may illustrate or emphasize common financial mistakes, which may help to prevent the customer representative from making such financial mistakes.

Customer representatives may interact with customer devices 12 to perform electronic transactions with customer service system 14. For example, using customer devices 12, a customer representative may enter financial values at entries included in a user interface for entering values for a particular financial report. In this example, customer devices 12 may submit the completed financial report to the financial institution network 13, via network 10.

In an example supply chain finance relationship, rather than waiting for the customer to pay an invoice or requiring that the customer pay the invoice on short payment terms, a vendor or distributor may receive advanced payment of the invoice from the financial institution based on a line of credit extended to the customer. In this way, the vendor may have immediate access to cash to be received for short-term accounts receivables, and the customer may have more working capital. As part of the supply chain finance relationship, the customer of the financial institution frequently (e.g., monthly) submits financial reports to the financial institution. The financial institution may use these periodic reports to ensure that the customer is in good financial standing and make any appropriate changes to the customer's line of credit.

To reduce an amount of time spent by company employees and representatives of a financial institutions, the customer of a financial institution may electronically generate, prepare, and submit financial reports. For example, a representative of a customer may generate, using customer devices 12 and financial institution network 13, a monthly financial report, consult relevant training documents of searchable library 22, enter values for the monthly financial report, and electronically submit the completed monthly financial report to the financial institution.

However, by electronically submitting financial reports, customer representatives may have less interaction with financial institution representatives compared to customer representatives who submit hard copy financial reports to the financial institution, e.g., by mail, courier, fax, or in person. That is, a customer representative electronically submitting a financial report may be less likely to request clarification or an explanation regarding financial values being input by the customer representative. In addition, a financial institution representative may be less likely to identify potential errors or issues in the electronic financial reports compared to the hard copy reports that may require data entry into the accounting system.

Moreover, a customer representative may be discouraged from utilizing training materials of searchable library 22. For example, customer representatives may be discouraged from necessarily searching through an amalgamation of useful and useless training documents within searchable library 22. In some examples, customer representatives unfamiliar with search syntax for searchable library 22 may be discouraged from necessarily configuring search syntax to search for a desired training document within searchable library 22. As such, a customer representative that uses electronic reporting may enter financial values that represent a best effort to provide information without consulting a financial expert at the financial institution or searchable library 22. Therefore, electronically reported financial values may include a higher relative occurrence of common financial errors or issues compared to hard copy reported financial values, particularly when the customer representative is unfamiliar with financial reports and/or lacking financial knowledge. Such banking errors may result in reductions to or even loss of the customer's credit line.

According to the disclosed techniques, computing device 18 of customer service system 14 may be configured to identify potential financial errors or issues in electronic financial reports. For example, computing device 18 may perform the identification of potential financial errors or issues by determining whether a financial value input by a customer representative at an entry of a user interface is outside of an expected range for the entry. The determination of whether the financial value input by the customer representative is outside of the expected range allows computing device 18 to efficiently identify one or more training materials of searchable library 22 that correspond to the entry that are most likely to be relevant to the customer representative.

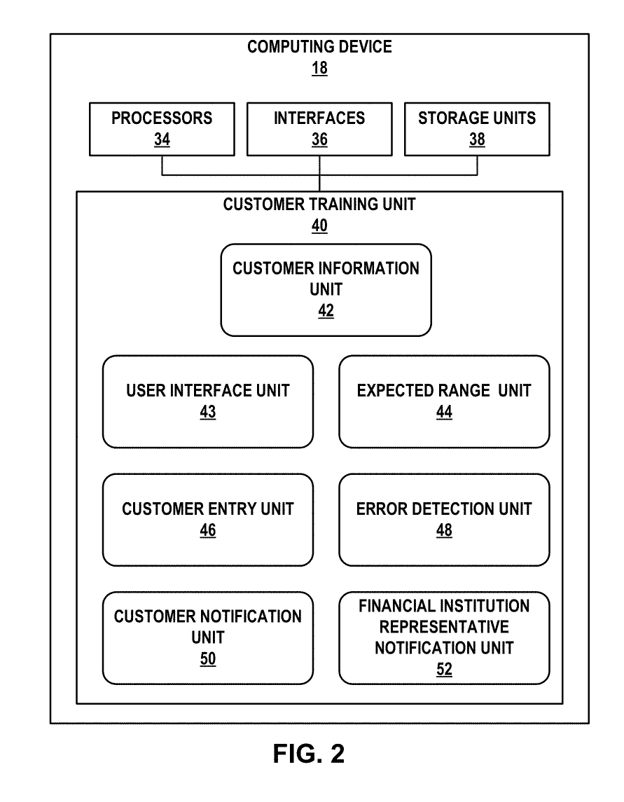

Computing device 18 may identify only training materials of searchable library 22 that correspond to entries that received financial values input by the customer representative that are outside of their respective expected range, which may greatly reduce a large number (e.g., hundreds, thousands, tens of thousands, etc.) of training documents in a searchable library to a useful number (e.g., 1, 10, etc.) of training documents. Computing device 18 may permit the customer representative to resubmit financial values that are updated in light of the identified training documents to help reduce an occurrence of common financial errors or issues in electronically submitted financial reports. In this way, computing device 18 may identify relevant training material within searchable library 22 to help to reduce an occurrence of potential financial errors or issues in electronic financial reports. The disclosed techniques, therefore, provide a technical solution of automatically identifying the financial errors or issues in electronic financial reports and automatically identifying training materials relevant to the identified errors or issues, that mitigates the overall higher relative occurrence of financial reporting errors arising out of electronic reporting. An example of computing device 18 within customer service system 14 is described in more detail below with respect to FIG. 2.

FIG. 2 is a block diagram illustrating an example of computing device 18 from FIG. 1 in more detail, including a customer training unit 40 configured to identify relevant training material within searchable library 22, in accordance with the techniques of this disclosure. The architecture of computing device 18 illustrated in FIG. 2 is shown for exemplary purposes only and computing device 18 should not be limited to this architecture. In other examples, computing device 18 may be configured in a variety of ways.

As shown in the example of FIG. 2, computing device 18 includes one or more processors 34, one or more interfaces 36, and one or more storage units 38. Computing device 18 also includes customer training unit 40, which may be implemented as program instructions and/or data stored in storage units 38 and executable by processors 34 or implemented as one or more hardware units or devices of computing device 18. Storage units 38 of computing device 18 may also store an operating system and a user interface unit executable by processors 34. The operating system stored in storage units 38 may control the operation of components of computing device 18. The components, units or modules of computing device 18 are coupled (physically, communicatively, and/or operatively) using communication channels for inter-component communications. In some examples, the communication channels may include a system bus, a network connection, an inter-process communication data structure, or any other method for communicating data.

Processors 34, in one example, may comprise one or more processors that are configured to implement functionality and/or process instructions for execution within computing device 18. For example, processors 34 may be capable of processing instructions stored by storage units 28. Processors 24 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Storage units 38 may be configured to store information within computing device 18 during operation. Storage units 38 may include a computer-readable storage medium or computer-readable storage device. In some examples, storage units 38 include one or more of a short-term memory or a long-term memory. Storage units 38 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, storage units 38 are used to store program instructions for execution by processors 34. Storage units 38 may be used by software or applications running on computing device 18 (e.g., customer training unit 40) to temporarily store information during program execution.

Computing device 18 may utilize interfaces 36 to communicate with external devices via one or more networks. Interfaces 36 may be network interfaces, such as Ethernet interfaces, optical transceivers, radio frequency (RF) transceivers, or any other type of devices that can send and receive information. Other examples of such network interfaces may include Wi-Fi or Bluetooth radios. In some examples, computing device 18 utilizes interfaces 36 to wirelessly communicate with external devices such searchable library 22.

Computing device 18 may include additional components that, for clarity, are not shown in FIG. 2. For example, computing device 18 may include a battery to provide power to the components of computing device 18. As another example, computing device 18 may include input and output user interface (UI) devices to communicate with an administrator of customer service system 14 or another user. Similarly, the components of computing device 18 shown in FIG. 2 may not be necessary in every example of computing device 18.

Customer training unit 40 may be considered an automatic chief financial officer that uses various financial information or a smart bot configured to access customer financial data directly from the customer, bank data/financial history from the bank, and external market data, and provide financial guidance to the customer as a virtual CFO. For example, customer training unit 40 may identify financial weaknesses or financial report issues/discrepancies of the customer, and send notifications to the customer including suggested solutions or links to targeted financial tutorials depending on the situation. Customer training unit 40 may provide a customer portal to a web-based searchable library of financial information and training materials. Customer training unit 40 may also auto-generate financial reports for the bank on behalf of the customer.

For example, customer training unit 40 may help to provide solutions to a customer that is attempting to export a balance sheet that does not balance. In some examples, customer training unit 40 may provide proactive guidance based on expenses versus revenue, cash flow, to bring a customer (e.g., business) to peer standards. In some examples, customer training unit 40 may suggest a credit line increase. In some examples, customer training unit 40 may inform a representative of a customer of upcoming expenses that the customer may not be able to pay and suggest solutions or offer advance credit at certain terms. In some examples, customer training unit 40 may warn against making purchases based on a financial status of a customer. In some examples, customer training unit 40 may provide human escalation. In some examples, customer training unit 40 may request information from a representative of a customer and provide training material based on response to the requested information. In some examples, customer training unit 40 may perform compliance monitoring and/or a compliance determination.

In the example illustrated in FIG. 2, customer training unit 40 includes customer information unit 42, user interface unit 43, expected range unit 44, customer entry unit 46, error detection unit 48, customer notification unit 50, and financial institution representative notification unit 52. According to the techniques of this disclosure, the components of customer training unit 40 of computing device 18 are configured to efficiently identify potential inconsistencies in financial values provided by a customer representative in order to identify relevant training material within a searchable library, e.g., searchable library 22 from FIG. 1.

Customer information unit 42 may receive customer information for a customer of a financial entity. For example, customer information unit 42 may initiate a transfer of customer information from customer network 15, financial institution database 21, or external financial database 20 of FIG. 1 to customer information unit 42 via network 10 and/or financial institution network 13 of FIG. 1. For instance, customer information unit 42 may receive customer information for a customer of a financial entity indicating an expected revenue. More specifically, for instance, customer information unit 42 may determine monthly sales cycle information from CRM information 16B, monthly accounts receivable and accounts payable information from AR and AP 16C, and/or proposals for expected monthly accounts receivable from customer proposal information 16N.

User interface unit 43 may generate a user interface. For example, in response to customer device 12A requesting a form for a monthly financial report, user interface unit 43 may generate a form that includes an entry for each financial value for the monthly financial report. Expected range unit 44 may determine an expected range for an entry included in a user interface based on the customer information. For example, expected range unit 44 may determine, based on the received customer information, that a particular entry of a user interface being presented at, e.g., customer device 12A of FIG. 1 corresponds to a particular range of financial values.

For example, in response to customer information unit 42 determining that monthly sales cycle information from CRM information 16B, monthly accounts receivable and accounts payable information from AR and AP 16C, and proposals for expected monthly accounts receivable from customer proposal information 16N indicate that a particular customer has an expected June accounts receivable of between $750,000 to $1,000,000, expected range unit 44 may determine an expected range for an entry corresponding to accounts receivable for June to be less one million dollars.

Expected range unit 44 may determine the expected range using a plurality of expected ranges. In this example, expected range unit 44 may select the expected range from a plurality of expected ranges using the customer information. For instance, in response to customer information unit 42 determining that monthly sales cycle information from CRM information 16B, monthly accounts receivable and accounts payable information from AR and AP 16C, and proposals for expected monthly accounts receivable from customer proposal information 16N indicates that a particular customer has an expected annual revenue of $1,500,000, expected range unit 44 may determine that the particular customer is a relatively small customer having an expected annual revenue of less than two million dollars. In this instance, each entry may have a corresponding value for each relative customer size (e.g., small, medium, large, etc.). In this instance, expected range unit 44 may select the expected range for an entry corresponding to accounts receivable for June to correspond to an expected range for a relatively small customer.

Expected range unit 44 may determine the expected range using a calculated expected range. For example, expected range unit 44 may calculate an expected range for accounts receivables using earnings. For instance, expected range unit 44 may directly calculate the expected range for accounts receivables for a particular period (e.g., month) to be between 50% to 150% of receivables for a previous period.

Customer entry unit 46 may receive, at the entry included in the user interface, an indication of a financial value that is input by a customer representative associated with the customer of the financial entity. For example, customer entry unit 46 may receive an indication of two million dollars at an entry of a form presented at the user interface that corresponds to an accounts receivable value for a month for the customer of the financial entity.

Customer entry unit 46 may generate financial values for an entry using customer information. For example, customer entry unit 46 may generate financial values for an entry for a covenant calculation corresponding to cash using a cash value from a monthly financial sheet of customer information 16. In some examples, customer entry unit 46 may generate financial values for an entry for a covenant calculation corresponding to accounts receivable using one or more values from a monthly financial sheet of customer information 16. In some examples, customer entry unit 46 may generate financial values for an entry using information of financial institution network 13 and/or external financial database 20.

Error detection unit 48 may determine whether the financial value is outside of the expected range for the entry. For example, in response to expected range unit 44 determining that the expected range at the entry corresponding to accounts receivable for a month is less one million dollars and customer entry unit 46 receiving the indication of two million dollars at the entry, error detection unit 48 may determine that the indication of two million dollars at the entry is a potential error. In response to determining that the financial issue has occurred, error detection unit 48 may identify one or more training documents based on the financial issue. For example, error detection unit 48 may identify one or more training documents that are associated with a search term corresponding to the financial issue. In some examples, error detection unit 48 may identify one or more training documents that are associated with a category corresponding to the financial issue.

Error detection unit 48 may identify a financial issue. Financial issues may refer to instances where customer information, information in external financial database 20, information in financial institution network 13, other information, or combinations thereof indicate that a financial value that is input by a customer representative associated with the customer of the financial entity is incorrect, potentially incorrect, or is otherwise inconsistent with the customer information, information in external financial database 20, information in financial institution network 13, other information, or combinations thereof. For example, in response to receiving a financial value that is input, at an entry of a user interface corresponding to an annual disbursement, by a customer representative indicating that owners of a business are taking out money at a time of year that does not correspond to an annual disbursement, error detection unit 48 may identify that a financial issue related to what money disbursements qualify as an annual disbursement has occurred.

Error detection unit 48 may identify a financial issue based on a financial value that is input by a customer representative associated with the customer of the financial entity and an expected range. For example, error detection unit 48 may determine that a financial issue has occurred when the financial value is outside of the expected range. Error detection unit 48 may identify a predicted financial issue using one or more predictive analytics on spending. For example, error detection unit 48 may identify a predicted financial issue relating to spending when one or more predictive analytics on spending indicate that current and expected spending is outside of expected values for the customer.

In some examples, in response to receiving a financial value that is input, at an entry of a user interface corresponding to a short term asset, by a customer representative indicating that short term assets amount to more than long term assets indicated by customer information, error detection unit 48 may identify that a financial issue related to what assets qualify as a short-term assets has occurred. In some examples, in response to receiving a financial value that is input, at an entry of a user interface corresponding to an asset, by a customer representative indicating a negative asset, error detection unit 48 may identify that a financial issue related to what qualifies as an asset compared to liability has occurred.

In some examples, in response to receiving a financial value that is input, at an entry of a user interface corresponding to receivables due immediately, by a customer representative indicating that receivables due immediately includes deferred receivables, error detection unit 48 may identify that a financial issue related to what assets qualify as receivables due immediately has occurred. In some examples, in response to receiving a financial value that is input, at an entry of a user interface corresponding to a liability, by a customer representative indicating that liabilities amount to 30% or greater of a balance sheet for the customer, error detection unit 48 may identify that a financial issue related to what qualifies as a liability has occurred.

Error detection unit 48 may identify a financial issue related to covenant calculations. For example, error detection unit 48 may identify a financial issue related to a covenant calculation using customer information indicating a per loan agreement. For instance, covenants may be calculated monthly and financials may be reported monthly. In this instance, error detection unit 48 may pre-empt the covenant calculation to identify inconstancies between the covenant calculation and the financials reported.

Error detection unit 48 may identify a financial issue related to a proposed financial transaction. For example, in response to receiving a financial value that is input, at an entry of a user interface corresponding to a proposed purchase, by a customer representative indicating that the proposed purchase trip (e.g., breach) a covenant of the customer, error detection unit 48 may identify that a financial issue related to what triggers a covenant would occurred if the proposed purchase is performed.

Customer notification unit 50 may output, to the customer representative via the user interface, based on the financial value being outside of the expected range for the entry, a notification indicating one or more training documents within a searchable library that corresponds to the entry. For example, in response to expected range unit 44 determining that the expected range at the entry corresponding to accounts receivable for a month is less one million dollars and customer entry unit 46 receiving the indication of two million dollars at the entry, customer notification unit 50 may cause a user interface at customer device 12A of FIG. 1 to display one or more training documents within searchable library 22 relating to how to calculate an accounts receivable value.

Customer notification unit 50 may generate a notification that includes web content. For example, customer notification unit 50 may generate the notification to includes an address of a website (e.g., weblink) that includes the one or more training documents. Customer notification unit 50 may generate a notification that includes an e-mail. For example, customer notification unit 50 may generate the notification to include an e-mail that includes an address of a website that includes the one or more training documents. Customer notification unit 50 may generate a notification that includes an option to talk to a human representative of the financial institution. For instance, customer notification unit 50 may generate a notification that includes a telephone number for the human representative, link to a chat software configured to initiate a chat session with the human representative, or other options to communicate with the human representative.

Customer notification unit 50 may be configured for periodic training. For example, customer notification unit 50 may generate a notification for one or more, two or more, etc. financial issues to be suggested on a periodic basis (e.g., once a quarter, once a month, once a week, once a day, etc.).

Financial institution representative notification unit 52 may output, to a representative of the financial institution, a notification indicating that the financial value is outside of the expected range when the financial value is outside of the expected range. For example, financial institution representative notification unit 52 may generate an e-mail to a representative of financial institution network 13 indicating that the input value of $2 million dollars per month for accounts receivable is outside of the expected range of less than $1 million for the customer of the financial institution. In some examples, financial institution representative notification unit 52 may output a notification to initiate an audit (e.g., by a human representative of the financial institution, by computing device 18, or another device of financial institution network 13) of a customer of financial institution network 13.

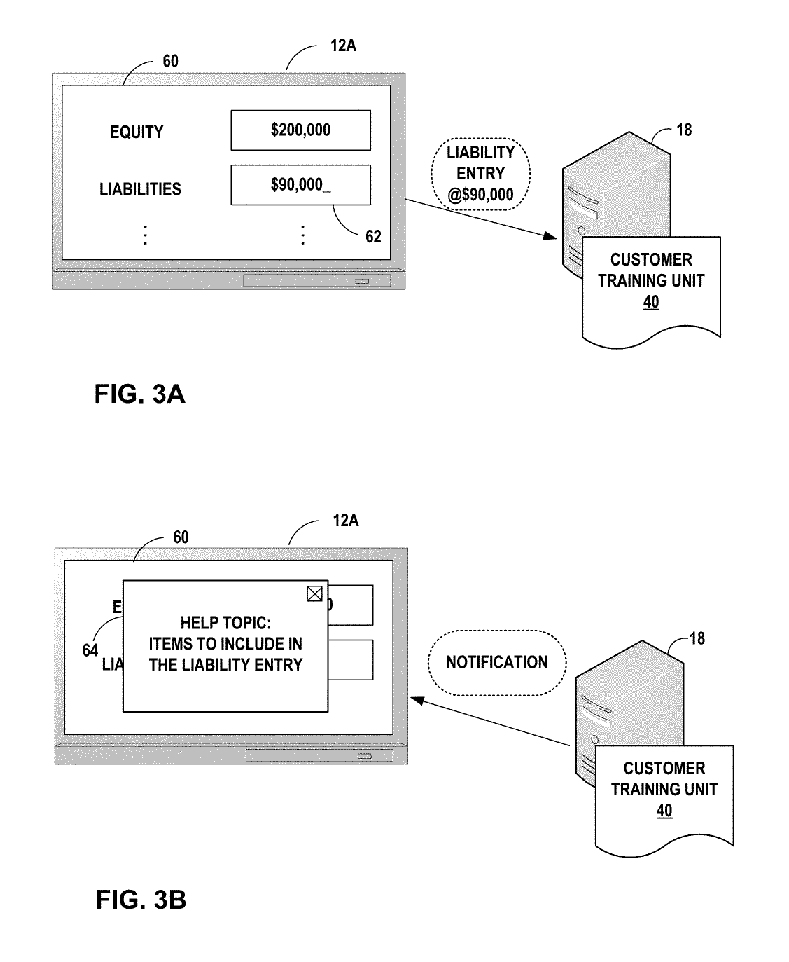

FIGS. 3A and 3B are conceptual diagrams illustrating one example user interface at a web browser of a computing device of FIG. 1. The example user interface illustrated in FIGS. 3A and 3B is merely one example of a user interface configured to receive a financial value and to output a notification. The user interface illustrated in FIGS. 3A and 3B is intended for purposes of description and should not be considered limiting.

In the example of FIG. 3A, customer device 12A executes a web-based application configured to access customer information of a customer (e.g., business) of a financial institution (e.g., bank) from the financial institution. Customer training unit 40 of computing device 18 may operate as a smart bot to identify a financial issue based on the customer information of the customer. In this example, user interface 60 may display a notification directing the representative of the customer to relevant training documents of a web-based searchable library (e.g., searchable library 22 of FIG. 1).

In the example of FIG. 3A, customer device 12A outputs user interface 60. In some examples, user interface 60 may represent an online portal application. As shown, user interface 60 illustrates a liabilities entry 62. As shown, customer device 12A has received an indication of a financial value of $90,000. For instance, customer device 12A may detect a selection of numbers “90000” at a keyboard. In response to detecting at entry 62 included in user interface 60, the indication of the financial value of $90,000 customer device 12A outputs an indication of the financial value of $90,000 at entry 62 (“LIABILITY ENTRY @ $90,000”) to customer training unit 40 of computing device 18.

In the example of FIG. 3B, customer training unit 40 determines that the financial value of $90,000 is outside of an expected range (e.g., 0 to $60,000) for entry 62 of FIG. 3A. In this example, customer training unit 40 outputs to customer device 12A a notification. In the example of FIG. 3B, notification 64 indicates one or more training documents within a searchable library that corresponds to entry 62 of FIG. 3A. For example, notification 64 indicates a training document that that explains how to calculate liabilities, a training document that explains that liabilities should typically not exceed 30% of equity, or another training document.

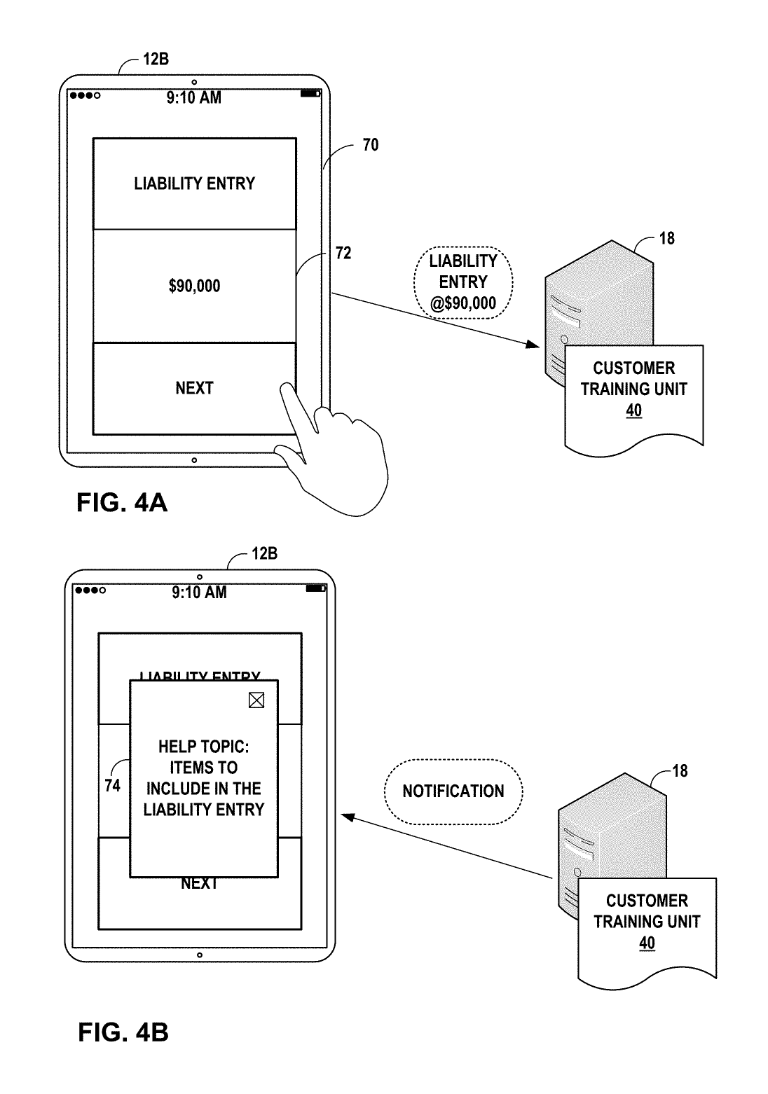

FIGS. 4A and 4B are conceptual diagrams illustrating one example user interface at a software application of a computing device of FIG. 1. The example user interface illustrated in FIGS. 4A and 4B is merely one example of a user interface configured to receive a financial value and to output a notification. The user interface illustrated in FIGS. 4A and 4B is intended for purposes of description and should not be considered limiting.

In the example of FIG. 4A, customer device 12B outputs user interface 70. In some examples, user interface 70 may represent a smart phone application for push notifications. As shown, user interface 70 illustrates a liabilities entry 72. As shown, customer device 12B has received an indication of a financial value of $90,000. For instance, customer device 12B may detect a selection of numbers “90000” at a soft keyboard. In response to detecting at entry 72 included in user interface 70, the indication of the financial value of $90,000 customer device 12B outputs an indication of the financial value of $90,000 at entry 72 (“LIABILITY ENTRY @ $90,000”) to customer training unit 40 of computing device 18.

In the example of FIG. 4B, customer training unit 40 determines that the financial value of $90,000 is outside of an expected range (e.g., 0 to $60,000) for entry 72 of FIG. 4A. In this example, customer training unit 40 of computing device 18 outputs to customer device 12B a notification. In the example of FIG. 4B, notification 74 indicates one or more training documents within a searchable library that corresponds to entry 72 of FIG. 4B. For example, notification 74 indicates a training document that that explains how to calculate liabilities, a training document that explains that liabilities should typically not exceed 30% of equity, or another training document.

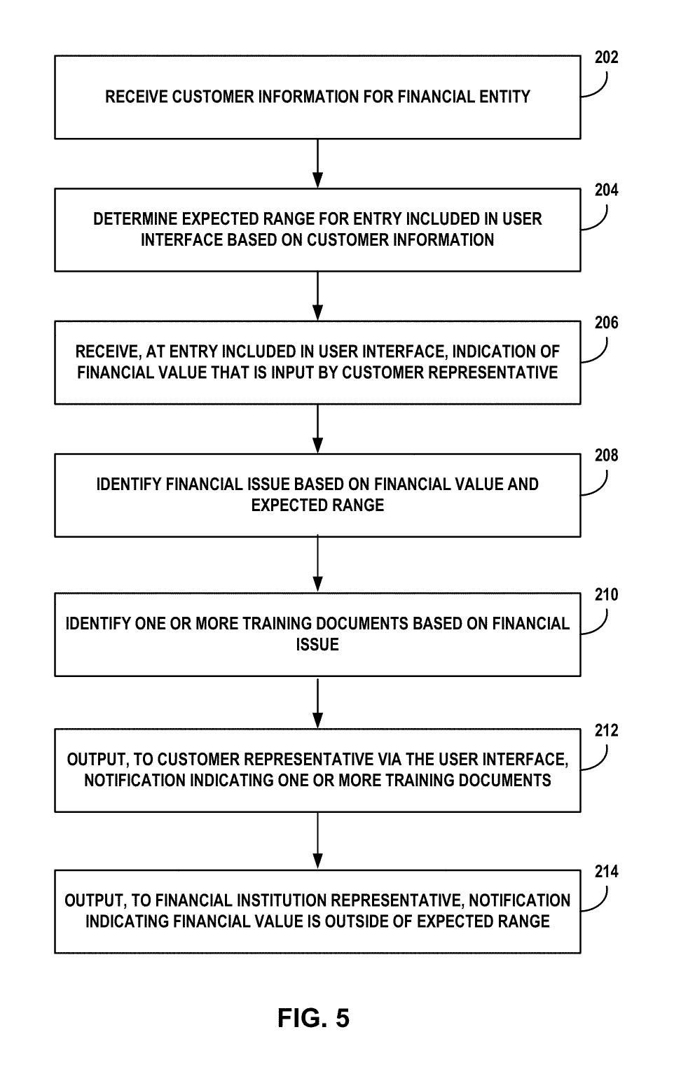

FIG. 5 is a flowchart illustrating an example operation of a computing device configured to identify relevant training material within a searchable library, in accordance with the techniques of this disclosure. The example operation of FIG. 5 is described with respect to computing device 18 within customer service system 14 from FIGS. 1 and 2 for exemplary purposes only.

Customer information unit 42 receives customer information for a financial entity (202). Expected range unit 44 determines an expected range for an entry included in a user interface based on customer information (204). Customer entry unit 46 receives, at an entry included in the user interface, an indication of a financial value that is input by a customer representative (206). Error detection unit 48 identifies a financial issue based on the financial value and the expected range (208). Error detection unit 48 identifies one or more training documents based on financial issue (210). Customer notification unit 50 outputs, to a customer representative via the user interface, a notification indicating the one or more training documents (212). Financial institution representative notification unit 52 outputs, to a financial institution representative, a notification indicating the financial value is outside of the expected range (214).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-based method comprising:
receiving, by a computing device, customer information for a customer of a financial entity;
determining, by the computing device, an expected range for an entry included in a user interface based on the customer information, the entry being configured to collect financial data from the customer for the financial entity;
receiving, by the computing device and at the entry included in the user interface, an indication of a financial value that is input by a customer representative associated with the customer of the financial entity; and
outputting, by the computing device and to the customer representative via the user interface, based on the financial value being outside of the expected range for the entry, a notification indicating one or more training documents within a searchable library that corresponds to the entry.

2. The method of claim 1, further comprising:
identifying, by the computing device, a financial issue based on the financial value and the expected range; and
identifying, by the computing device, the one or more training documents based on the financial issue.

3. The method of claim 1, wherein determining the expected range comprises:
selecting the expected range from a plurality of expected ranges using the customer information.

4. The method of claim 1, wherein determining the expected range comprises:
calculating the expected range using the customer information.

5. The method of claim 1, wherein the notification comprises web content and wherein, to indicate the one or more training documents, the web content includes an address of a website that includes the one or more training documents.

6. The method of claim 1, wherein the notification comprises an e-mail and wherein, to indicate the one or more training documents, the e-mail includes an address of a web site that includes the one or more training documents.

7. The method of claim 1, further comprising:
outputting, by the computing device and to a representative of the financial institution, a notification indicating that the financial value is outside of the expected range when the financial value is outside of the expected range.

8. A computing device comprising:
a memory configured to store customer information for a customer of a financial entity; and
at least one processor in communication with the memory, the at least one processor being configured to:
determine an expected range for an entry included in a user interface based on the customer information, the entry being configured to collect financial data from the customer for the financial entity;
receive, at the entry included in the user interface, an indication of a financial value that is input by a customer representative associated with the customer of the financial entity; and
output, to the customer representative via the user interface, based on the financial value being outside of the expected range for the entry, a notification indicating one or more training documents within a searchable library that corresponds to the entry.

9. The device of claim 8, wherein the at least one processor is further configured to:
identify a financial issue based on the financial value and the expected range; and
identify the one or more training documents based on the financial issue.

10. The device of claim 8, wherein, to determine the expected range, the at least one processor is configured to:
select the expected range from a plurality of expected ranges using the customer information.

11. The device of claim 8, wherein, to determine the expected range, the at least one processor is configured to:
calculate the expected range using the customer information.

12. The device of claim 8, wherein the notification comprises web content and wherein, to indicate the one or more training documents, the web content includes an address of a website that includes the one or more training documents.

13. The device of claim 8, wherein the notification comprises an e-mail and wherein, to indicate the one or more training documents, the e-mail includes an address of a website that includes the one or more training documents.

14. The device of claim 8, wherein the at least one processor is further configured to:
output, to a representative of the financial institution, a notification indicating that the financial value is outside of the expected range when the financial value is outside of the expected range.

15. A non-transitory computer readable storage medium comprising instructions, that when executed, cause one or more processors of a computing device to:
receive customer information for a customer of a financial entity;
determine an expected range for an entry included in a user interface based on the customer information, the entry being configured to collect financial data from the customer for the financial entity;
receive, at the entry included in the user interface, an indication of a financial value that is input by a customer representative associated with the customer of the financial entity; and
output, to the customer representative via the user interface, based on the financial value being outside of the expected range for the entry, a notification indicating one or more training documents within a searchable library that corresponds to the entry.

16. The non-transitory computer-readable storage medium of claim 15, further comprising instructions that, when executed, cause the one or more processors to:
identify a financial issue based on the financial value and the expected range; and
identify the one or more training documents based on the financial issue.

17. The non-transitory computer-readable storage medium of claim 15, wherein, to determine the expected range, the instruction further cause the one or more processors to:
select the expected range from a plurality of expected ranges using the customer information.

18. The non-transitory computer-readable storage medium of claim 15, wherein, to determine the expected range, the instruction further cause the one or more processors to:
calculate the expected range using the customer information.

19. The non-transitory computer-readable storage medium of claim 15, wherein the notification comprises web content and wherein, to indicate the one or more training documents, the web content includes an address of a web site that includes the one or more training documents.

20. The non-transitory computer-readable storage medium of claim 15, wherein the notification comprises an e-mail and wherein, to indicate the one or more training documents, the e-mail includes an address of a web site that includes the one or more training documents.
